(19) United States
(12) Patent Application Publication
(10) Pub. No.: US 2025/0180723 A1
(43) Pub. Date: Jun. 5, 2025

(54) DETECTION DEVICE AND METHOD OF OPERATING SAME

(71) Applicant: Samsung Electronics Co., Ltd., Suwon-si (KR)

(72) Inventors: Kyungwoo YOO, Suwon-si (KR); Dooseok CHOI, Suwon-si (KR)

(73) Assignee: Samsung Electronics Co., Ltd., Suwon-si (KR)

(21) Appl. No.: 18/945,934

(22) Filed: Nov. 13, 2024

(30) Foreign Application Priority Data
Dec. 1, 2023 (KR) 10-2023-0172744
Apr. 3, 2024 (KR) 10-2024-0045552

(51) Int. Cl. G01S 13/04; G01S 7/40

(52) U.S. Cl. CPC G01S 13/04; G01S 7/4008

(57) ABSTRACT

A detection device includes processing circuitry configured to perform range Fourier transform on a plurality of pulse signals to obtain first Fourier transform data, perform Doppler Fourier transform on the first Fourier transform data to obtain second Fourier transform data, maintain a reference signal in response to determining the second Fourier transform data includes a non-zero Doppler value, update the reference signal in response to determining the second Fourier transform data does not include any non-zero Doppler values, and determine that a body exists in response to determining a signal magnitude of the plurality of pulse signals is lower than a threshold value, remove the reference signal from the first Fourier transform data in response to determining the signal magnitude is higher than the threshold value to obtain corrected data, and detect that the body exists based on a constant false alarm rate (CFAR) for the corrected data.

### CROSS-REFERENCE TO RELATED APPLICATIONS

This application claims priority under 35 U.S.C. § 119 to Korean Patent Application Nos. 10-2023-0172744 filed on Dec. 1, 2023, and 10-2024-0045552 filed on Apr. 3, 2024, in the Korean Intellectual Property Office, the disclosures of each of which are incorporated by reference herein in their entireties.

### BACKGROUND

Embodiments of the present disclosure described herein relate to a detection device and a method of operating the same.

Because the communication quality of wireless communication is directly related to a signal-to-noise ratio (SNR), improvements in the SNR may provide improvements to communication quality. SNR improvements involving increasing electromagnetic waves, to which a human body may be exposed, may also involve adjustments to transmission power depending on whether a human body exists near an antenna. Body proximity sensing (BPS) may be used to determine whether a human body exists around the antenna.

In a body proximity sensing technology, a detection target may be falsely detected or not detected due to changes in the surrounding environment where the detection target exists or the presence of surrounding objects.

### SUMMARY

Embodiments of the present disclosure provide a detection device that is capable of reducing false detections and performing ultra-close range detection, and a method operating the same. According to embodiments, technology is provided for accurately detecting only the human body that is the target of detection.

According to embodiments, a detection device includes processing circuitry configured to perform range Fourier transform on a plurality of pulse signals to obtain first Fourier transform data, perform Doppler Fourier transform on the first Fourier transform data to obtain second Fourier transform data, maintain a reference signal in response to determining the second Fourier transform data includes a non-zero Doppler value, update the reference signal in response to determining the second Fourier transform data does not include any non-zero Doppler values, and determine that a body exists in response to determining a signal magnitude of the plurality of pulse signals is lower than a threshold value, remove the reference signal from the first Fourier transform data in response to determining the signal magnitude is higher than the threshold value to obtain corrected first Fourier transform data, and detect that the body exists based on a constant false alarm rate (CFAR) for the corrected first Fourier transform data.

According to embodiments, a method of operating a detection device includes performing range Fourier transform on a plurality of pulse signals to obtain first Fourier transform data, performing Doppler Fourier transform on the first Fourier transform data to obtain second Fourier transform data, and detecting that a body exists in response to a signal magnitude of the plurality of pulse signals being lower than a threshold value, or based on a constant false alarm rate (CFAR) for corrected first Fourier transform data, the corrected first Fourier transform data being obtained by removing a reference signal from the first Fourier transform data in response to the signal magnitude being higher than the threshold value, the reference signal being one of a first reference signal maintained in response to determining the second Fourier transform data includes a non-zero Doppler value, or a second reference signal updated in response to determining the second Fourier transform data does not include any non-zero Doppler values.

According to embodiments, a detection device includes a transceiver configured to transmit and receive a plurality of pulse signals, and processing circuitry electrically connected to the transceiver, the processing circuitry being configured to maintain a reference signal in response to determining Doppler Fourier transform data on the plurality of pulse signals includes a non-zero Doppler value, update the reference signal in response to determining the Doppler Fourier transform data does not include any non-zero Doppler value, determine that a body exists in response to determining a signal magnitude of the plurality of pulse signals is lower than a threshold value, remove the reference signal from range Fourier transform data for the plurality of pulse signals in response to determining the signal magnitude is higher than the threshold value to obtain corrected range Fourier transform data, and detect that the body exists based on a constant false alarm rate (CFAR) for the corrected range Fourier transform data.

According to embodiments, it is possible to provide a detection device that is capable of reducing false detections and performing ultra-close range detection, and a method of operating the same.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a detection device according to embodiments.

FIG. 2 is a block diagram illustrating a detection device according to embodiments.

FIG. 3 is a diagram illustrating a calibration operation of a detection device according to embodiments.

FIG. 4 illustrates a calibration operation of a detection device according to embodiments.

FIG. 5 is a diagram illustrating the operation of a detection device according to embodiments.

FIG. 6 is a block diagram illustrating a calibration circuit according to embodiments.

FIGS. 7 to 9 are block diagrams illustrating detection circuits according to embodiments.

FIG. 10 is a flowchart illustrating a method of operating a detection device according to embodiments.

FIG. 11 is a flowchart illustrating a method of operating a detection device according to embodiments.

FIG. 12 is a flowchart illustrating a detection method of a detection device according to embodiments.

FIG. 13 is a flowchart illustrating a detection method of a detection device according to embodiments.

FIG. 14 is a diagram illustrating a result of range Fourier transform according to embodiments.

FIG. 15 is a diagram illustrating detection results according to embodiments.

### DETAILED DESCRIPTION

Hereinafter, embodiments of the present disclosure will be described clearly and in detail so that those skilled in the art may easily carry out embodiments of the present disclosure.

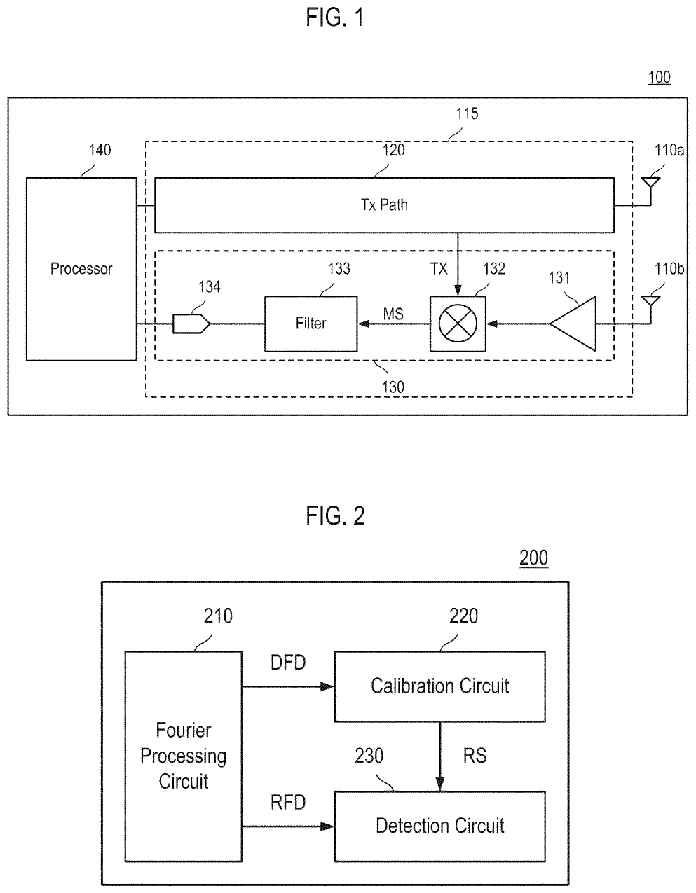

FIG. 1 is a block diagram illustrating a detection device according to embodiments.

Referring to FIG. 1, a detection device 100 according to embodiments may include a plurality of antennas 110a and 110b, a transceiver 115, and/or a processor 140.

Among the plurality of antennas 110a and 110b, the transmission antenna 110a may transmit a transmission signal generated from a transmission path 120 to an outside (e.g., outside of the detection device 100, for example, to another device). The reception antenna 110b may provide a reception signal received from the outside to a reception path 130. Unlike as shown, according to embodiments, a plurality of transmitting antennas 110a and/or reception antennas 110b may be provided, or a single transmission and reception antenna may be provided. According to embodiments, the antenna may include an array antenna.

The transceiver 115, which is configured to transmit and receive a plurality of pulse signals, may include the transmission path 120 and the reception path 130.

The transmission path 120 may convert a digital signal generated by the processor 140 into a transmission signal in the analog domain or process the converted transmission signal. The transmission path 120 may include a filter, a mixer, an amplifier, and various other components for converting, generating, and processing transmission signals.

According to embodiments, the transmission path 120 may generate a plurality of pulse signals as a transmission signal through an oscillator (not shown). For example, each pulse signal may include a continuous wave (CW) signal and a frequency modulated continuous wave (FMCW) signal. A signal frequency-modulated through FMCW may be referred to as a chirp. For example, a chirp may have a frequency that changes linearly through linear frequency modulation (LFM). In this case, the chirp may have the form of a sawtooth wave. Alternatively, the chirp may have a stepped frequency (SF) waveform.

According to embodiments, the transmission path 120 may sequentially transmit a plurality of frequency modulated chirps. Each chirp may be transmitted every pulse repetition interval (PRI) period.

The reception path 130 may process a reception signal received from an outside and convert the processed signal into a reception signal in the digital domain. Like the transmission signal, the reception signal may be a plurality of pulse signals. One reception pulse signal for one transmission pulse signal may be received through the reception path 130 after a round-trip time in the time domain.

According to embodiments, the reception path 130 may include a low-noise amplifier (LNA) 131, a mixer 132, a filter 133, and/or an analog-to-digital converter (ADC) 134. The low-noise amplifier 131 may low-noise amplify the reception signal and provide the reception signal to the mixer 132. The mixer 132 may mix the transmission signal and the reception signal provided from the reception path 130 to output a mixing signal MS. The mixing signal MS may be referred to as an IF signal or a dechirped signal, and may have a frequency corresponding to the difference between the frequency of the transmission signal and the frequency of the reception signal. The frequency of the mixing signal MS may be referred to as a beat frequency.

The filter 133 may be configured to filter the mixing signal MS, which is a signal provided from the mixer 132. For example, the filter 133 may be implemented as a low pass filter (LPF), a high pass filter (HPF), etc. to filter a specific band of the mixing signal MS. For example, when the detection device 100 is configured to detect a target at a close range or an ultra-close range, the filter 133 may be implemented as the HPF to reduce the influence of leakage signals. The filtered signal may be converted from the analog domain to the digital domain through the ADC 134 and transmitted to the processor 140.

The processor 140 may process a digital signal including information to be transmitted or process a reception signal.

According to embodiments, the processor 140 may perform various operations to detect a target in a reception signal. The processor 140 may perform calibration to remove signals to be removed that are not related to the reception signal to be detected, that is, the reflected signal reflected by a human body. Hereinafter, the signal to be removed may be referred to as a reference signal. The reference signal may be defined as various signals unrelated to the target such as a spillover signal in which a transmission signal transmitted through a transmission path leaks into a reception path, a reflection signal due to a static object (or stationary clutter) around the detection device 100, and the like.

The processor 140 may update or maintain a reference signal to be removed through calibration. A reference signal that is updated or maintained may be used for a detection operation. The processor 140 may perform target detection based on the reference signal. Hereinafter, the calibration and detection operations of the processor 140 will be described in more detail.

First, the processor 140 may obtain range Fourier transform data and Doppler Fourier transform data through range-Doppler Fourier transform on a plurality of pulse signals. The Doppler Fourier transform data may be defined as a range-Doppler map. Range Fourier transform data may be used for detection and the Doppler Fourier transform data may be used for calibration.

The processor 140 may determine whether a non-zero Doppler value exists in the Doppler Fourier transform data. According to embodiments, the processor 140 may determine whether a non-zero Doppler value exists based on a constant false alarm rate (CFAR).

Typically, the non-zero Doppler value in the Doppler Fourier transform data indicates the presence of a moving human body. For example, when a human body exists, a non-zero Doppler value may appear compared with the case where an object exists due to the movement of the human body or microscopic movements caused by the human body, such as breathing, heartbeat, and the like. The Doppler Fourier transform data for motionless objects other than a human body have a number of zero Doppler values. According to embodiments, references herein to a human body may refer to any body (e.g., a human, an animal, another object, etc.). Discussion herein will mainly focus on the example of a human body for expedience. According to embodiments, reference herein to the existence of a human body may refer to the presence of a body within a threshold proximity (e.g., to the detection device 100, one or more of the antennas 110a and 110b, etc.). The threshold proximity may correspond to a distance (e.g., from the detection device 100, one or more of the antennas 110a and 110b, etc.) within which the detection device 100 (or a device containing the detection device 100) would reduce a transmission power of a communication signal or skip transmission of the communication signal. The threshold proximity may be based on regulations of a governing body. Additionally or alternatively, the threshold proximity may be a design parameter determined through empirical study.

Accordingly, the processor 140 may determine whether a human body exists based on the Doppler Fourier transform data and determines whether to update the reference signal in use. When there is no non-zero Doppler value, the surrounding environment containing only a stationary object may still be considered to be maintained. When a human body enters a detection range, there may be a non-zero Doppler value.

The processor 140 may update the reference signal based on the absence of a non-zero Doppler value. That is, when the processor 140 determines that no human body is detected nearby through detection based on the Doppler Fourier transform data (e.g., in response to determining that the Doppler Fourier transform data does not include any non-zero Doppler value), the processor 140 may update the reference signal. This is because the reference signal is a signal that may be removed in a later detection operation, and therefore may be continuously updated to properly reflect the surrounding environment.

According to embodiments, the update may be performed based on a pulse signal transmitted and received before the update time (e.g., the calibration time) and range Fourier transform data of the corresponding pulse signal.

Alternatively, the processor 140 may maintain a reference signal based on the presence of a non-zero Doppler value (e.g., in response to determining that the Doppler Fourier transform data includes a non-zero Doppler value). That is, when it is determined that a human body enters (or been detected) the detection range, the Doppler Fourier transform data due to the human body should no longer (or should not) be reflected in the reference signal, so the processor 140 does not perform update. In other words, by maintaining the reference signal, signal changes caused by the human body may not be reflected in the reference signal.

The processor 140 may end calibration based on the above-described examples and perform detection based on an updated or maintained reference signal.

According to embodiments, the processor 140 may perform primary detection depending on whether a human body is located in the very near or near range before CFAR. In addition, the processor 140 may first perform detection in an ultra-short range by comparing signal magnitudes of a plurality of pulse signals with a threshold value. The threshold value may be set variously according to embodiments.

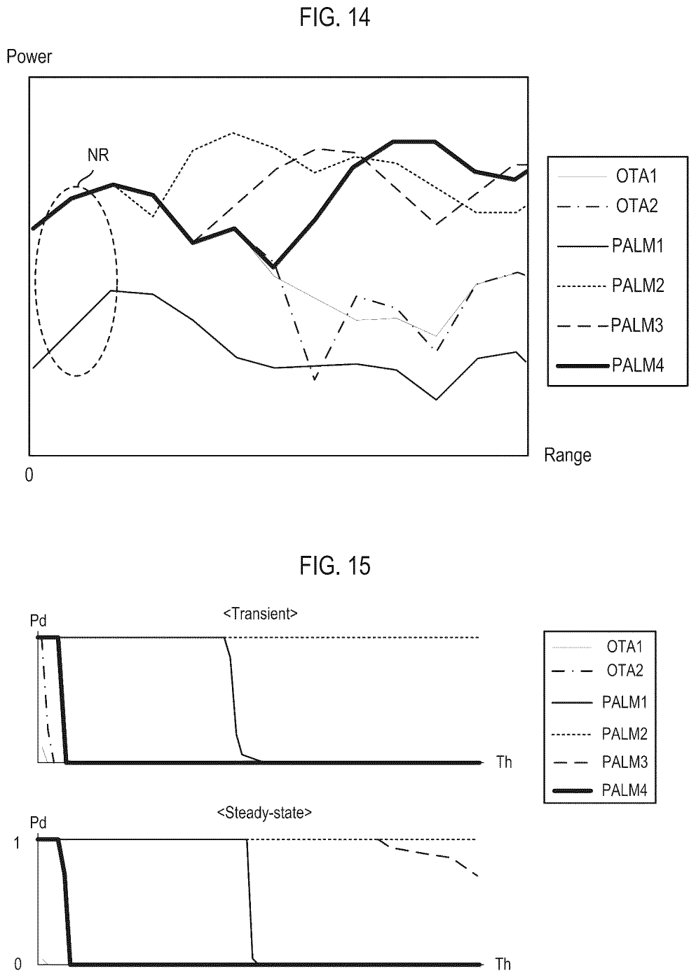

The processor 140 may determine that a human body exists based on the fact that the signal magnitudes of the plurality of pulse signals are lower than the threshold value. The signal magnitude of the pulse signal may be greatly reduced when a human body is very close to the detection device 100. This is because, when a human body is very close to the antenna of the detection device 100, it is difficult to emit a pulse signal from the antenna. Accordingly, the processor 140 may determine that a human body exists by considering that the human body exists at a very close distance when the signal magnitude is lower than the threshold value. According to embodiments, references herein to a very close distance may refer to a distance of 0 cm, distance d1 discussed in association with FIG. 14 below, or another distance (e.g., a design parameter determined through empirical study).

Alternatively or additionally, the processor 140 may perform secondary detection based on the fact that the signal magnitude is higher than the threshold value. Basically, secondary detection may be performed based on CFAR. First, the processor 140 may remove the reference signal updated or maintained through calibration from the range Fourier transform data. According to the removal of the reference signal, the corrected range Fourier transform data may be in a state where all background signals are removed except for the signal level caused by the human body.

Accordingly, the processor 140 may detect a human body through CFAR on the range Fourier transform data corrected according to the removal.

According to the above-described examples, the detection device 100 updates or maintains a reference signal by the surrounding environment in advance through calibration, and perform the detection based on the range Fourier transform data corrected according to removal of the reference signal. Accordingly, false detections due to surrounding stationary objects and the like may be reduced. In addition, the detection device 100 is capable of detecting a human body at a very close distance based on the signal magnitude.

FIG. 2 is a block diagram illustrating a detection device according to embodiments.

Referring to FIG. 2, a detection device 200 according to embodiments may include a Fourier processing circuit 210, a calibration circuit 220, and/or a detection circuit 230. At least some of the Fourier processing circuit 210, the calibration circuit 220, and the detection circuit 230 may be configured to perform some of the functions or operations performed by the processor 140 of FIG. 1 described above.

The Fourier processing circuit 210 may be configured to perform range Fourier transform and/or Doppler Fourier transform. For example, the Fourier processing circuit 210 may perform Fourier transform, such as fast Fourier transform (FFT).

According to embodiments, the Fourier processing circuit 210 may perform window functions and algorithms, such as Hanning, Hamming, Blackman-Nuttall, and the like, to reduce side lobes when performing range Fourier transform. Through the window function(s) described above as an example, false detections due to a human body existing outside the detection target range may be reduced.

According to embodiments, the Fourier processing circuit 210 may obtain range Fourier transform data RFD shown as a spectrum according to distance through range Fourier transform on a plurality of pulse signals. In the range Fourier transform data RFD, a peak appears at the distance where a target is located.

The Fourier processing circuit 210 may obtain, through Doppler Fourier transform on the range Fourier transform data RFD, Doppler Fourier transform data DFD which is depicted as a range-Doppler spectrum (or which may be referred to as range-Doppler Fourier transform data DFD). For example, the Fourier processing circuit 210 may perform Doppler Fourier transform by performing Fourier transform along the pulse axis for each distance bin of the range Fourier transform data RFD obtained for each pulse. Therefore, the Doppler Fourier transform data DFD may be expressed as a spectrum of the distance axis and the Doppler axis.

The calibration circuit 220 may update or maintain a reference signal RS. In detail, the calibration circuit 220 may maintain the reference signal RS based on the presence of non-zero Doppler values in the Doppler Fourier transform data DFD and update the reference signal RS based on the absence of non-zero Doppler values in the Doppler Fourier transform data DFD. The calibration circuit 220 may determine whether the non-zero Doppler value exists through CFAR for Doppler Fourier transform.

According to embodiments, the calibration circuit 220 may update or maintain the reference signal RS in units of a plurality of calibration sections. That is, the reference signal RS may be updated or maintained in units of a plurality of calibration sections. According to embodiments, the reference signal RS may be updated or maintained in a calibration section by calibration section basis, such that an entire calibration section is either updated or maintained at a time. The reference signal RS updated or maintained through each calibration section may be used in the detection section corresponding to one calibration section.

In each detection section, a plurality of pulse signals may be transmitted and received for detection. Considering that calibration is performed before detection, at least a portion of one calibration section may precede the corresponding detection section in the time domain. In addition, the size of one calibration section in the time domain may be the same as (or similar to) the size of one detection section.

When the section in which calibration is first performed is defined as a first calibration section and the corresponding detection section is defined as a first detection section, the reference signal RS is set to an initial value in the first calibration section. That is, in the first detection section, the initial value is used as the reference signal RS.

Thereafter, when one calibration section has elapsed, the calibration circuit 220 may determine whether to update or maintain the reference signal RS used in the previous section. For example, in a second calibration section after the first calibration section, the reference signal RS to be updated or maintained may have an initial value. In the subsequent calibration section (e.g., the (k+1)-th calibration section where ‘k’ is a natural number of 3 or more), the reference signal RS to be updated or maintained may be used in the immediately previous (or previous) calibration section (e.g., the k-th calibration section).

According to embodiments, the calibration circuit 220 may maintain the reference signal RS at the initial value based on maintaining the reference signal RS in the second calibration section. Alternatively, the calibration circuit 220 may calculate an average value of the range Fourier transform data RFD corresponding to the first calibration section (e.g., the range Fourier transform data RFD in the first detection section) based on updating the reference signal RS in the second calibration section, and may update the reference signal RS to the average value.

Thereafter, when it is desired to maintain the reference signal RS in the (k+1)-th calibration section, the calibration circuit 220 may maintain the reference signal RS as the reference signal RS in the k-th calibration section. Alternatively, when it is desired to update the reference signal RS in the (k+1)-th calibration section, the calibration circuit 220 may calculate an average value of the range Fourier transform data RFD corresponding to the k-th calibration section (e.g., the range Fourier transform data of the k-th detection section), and may update the reference signal RS to the average value.

Therefore, changes in the surrounding environment may be accurately reflected in the reference signal RS through the calibration circuit 220.

The detection circuit 230 may determine that a human body is present based on the signal magnitude of the plurality of pulse signals being lower than a threshold value. As described above, the signal magnitude of the plurality of pulse signals shows different aspects depending on whether a human body is very close to the detection device 200, and in particular, when the human body is very close, the signal magnitude appears to be reduced. Accordingly, the detection circuit 230 immediately (or promptly) determines that a human body exists when the signal magnitude is lower than the threshold value.

Alternatively, the detection circuit 230 may remove the reference signal RS from the range Fourier transform data RFD based on the signal magnitude being higher than the threshold value. Thereafter, the detection circuit 230 may detect a human body through CFAR on the range Fourier transform data corrected according to the removal. The detection circuit 230 may determine that a human body exists based on a detection flag according to CFAR indicating a specific value (e.g., logic high).

According to embodiments, the target signal magnitude for determining whether a human body is very close thereto may be defined in various manners. For example, the signal magnitude may be defined as the magnitude of each of a plurality of samples included in the range Fourier transform data RFD. In this case, the signal magnitude may be determined as the signal level in the range bin domain of the range Fourier transform data RFD. The detection circuit 230 may determine whether a human body is very close thereto by comparing the signal magnitude of the range Fourier transform data RFD and the threshold value.

Alternatively or additionally, for example, the signal magnitude may be defined as the magnitude of a plurality of pulse signals in the time domain. The detection circuit 230 may determine whether a human body is very close thereto by comparing the threshold value and the signal magnitudes of a plurality of pulse signals before the Range Fourier transform.

Alternatively or additionally, the detection circuit 230 according to embodiments may directly perform an operation of removing the reference signal RS and an operation of detecting a human body based on CFAR without comparing the signal magnitude and threshold value.

According to the above-described examples, the detection device 200 may reduce false detections caused by surrounding stationary objects, and the like through calibration and removal of the reference signal RS. In addition, the detection device 200 may detect a human body at a very close distance based on a signal magnitude.

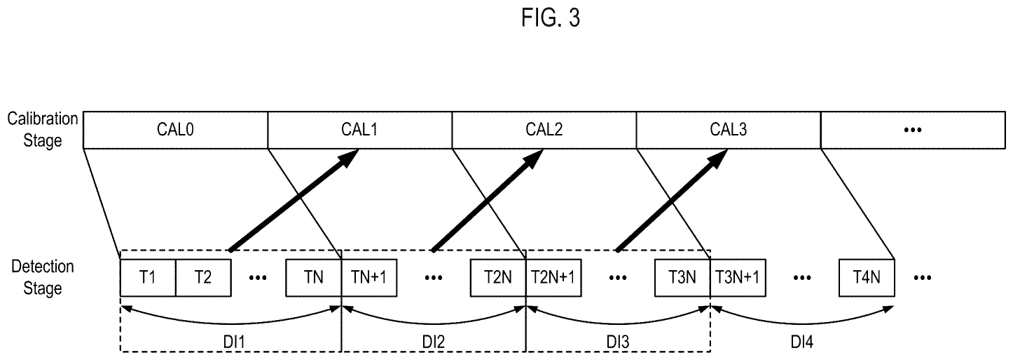

FIG. 3 is a diagram illustrating a calibration operation of a detection device according to embodiments.

Referring to FIG. 3, a detection device according to embodiments may perform calibration for each calibration section included in a plurality of calibration sections CAL0 to CAL3 (also referred to herein as calibration stages), and perform detection for each detection section included in a plurality of detection sections DI1 to DI4 (also referred to herein as detection stages) corresponding to (e.g., respectively corresponding to) the plurality of calibration sections CAL0 to CAL3. One calibration section (e.g., each calibration section) may correspond to one detection section (e.g., only one detection section), and the corresponding calibration and detection sections may have the same size (or similar sizes).

In the first calibration section CAL0, calibration according to the above-described examples does not substantially occur, and the reference signal has an initial value for the first calibration section CAL0.

From the second calibration section CAL1, a plurality of pulse signals transmitted and received in the detection section corresponding to the immediately preceding (or preceding) calibration section are used to update the reference signal. When the reference signal is to be updated in the second calibration section CAL1 (e.g., when there is no non-zero Doppler value in the Doppler Fourier transform data), N (where N is a natural number) pulses included in the first detection section DI1 may be used for update. Sequentially, when the reference signal is to be updated in the third calibration section CAL2, N pulse signals included in the second detection section DI2 are used for update, and when the reference signal is to be updated in the fourth calibration section CAL3, N pulse signals included in the third detection section DI3 may be used for update.

Like updating, even when the reference signal must (or otherwise, would) be maintained (e.g., when a non-zero Doppler value exists in the Doppler Fourier transform data), the reference signal used in the previous calibration section may be maintained as it is. For example, when it is determined to maintain the reference signal in the third calibration section CAL2, the reference signal of the second calibration section CAL1 may be maintained as it is. In other words, the reference signal for a specific calibration section may be valid during the next calibration section.

According to the above-described examples, the detection device may reduce false detections in the detection section by updating or maintaining the reference signal using the pulse signal transmitted and received before detection.

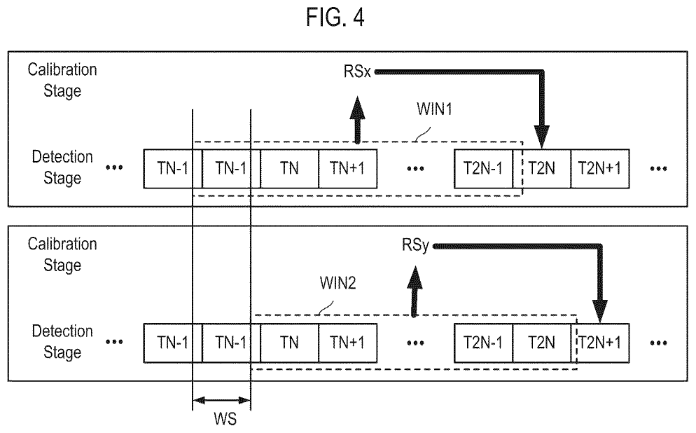

FIG. 4 illustrates a calibration operation of a detection device according to embodiments.

Referring to FIG. 4, a detection device according to embodiments may perform calibration of the reference signal based on a window movable in units of unit pulse signal sections (e.g., one pulse signal included in one detection section of FIG. 3). In this case, the reference signal updated or maintained through calibration may be valid only for the next detection interval to which the window is applied. That is, the reference signal may be updated or maintained in units of at least one pulse signal section. According to embodiments, the reference signal may be updated or maintained on a pulse signal section by pulse signal section basis (or window by window basis), such that an entire pulse signal section (or window) is either updated or maintained at a time.

For example, a reference signal RSx to be used in the 2N-th pulse signal section (e.g., the reference signal to be removed from the range Fourier transform data of the 2N-th pulse signal) may be updated through pulse signal sections (e.g., the (N−1)-th pulse signal to the (2N−1)-th pulse signal) included in the window WIN1 having size N before the 2N-th pulse signal. Of course, when the reference signal is maintained, the reference signal, which is obtained through calibration at an arbitrary (or otherwise, given) time before the 2N-th pulse signal, may be used.

As another example, a reference signal RSy to be used in the (2N+1)-th pulse signal section (e.g., the reference signal to be removed from the range Fourier transform data of the (2N+1)-th pulse signal) may be updated through the pulse signal sections (e.g., the N-th to the 2N-th pulse signals) included in a window WIN2 having size N before the (2N+1)-th pulse signal. Of course, when the reference signal is maintained, the reference signal obtained through calibration at an arbitrary (or otherwise, given) time before the (2N+1)-th pulse signal may be used.

According to the above-described examples, the detection device may update or maintain the reference signal to be used in the detection section while moving (or overlapping) the windows WIN1 and WIN2 every window movement unit WS. Although the illustrated window movement unit WS is defined as one pulse signal section, those skilled in the art will understand that the window movement unit WS may be defined to have various other time periods.

According to the above-described examples, the detection device may update or maintain the reference signal through a window capable of being overlapped, thereby making the reference signal more useful for detection in real time.

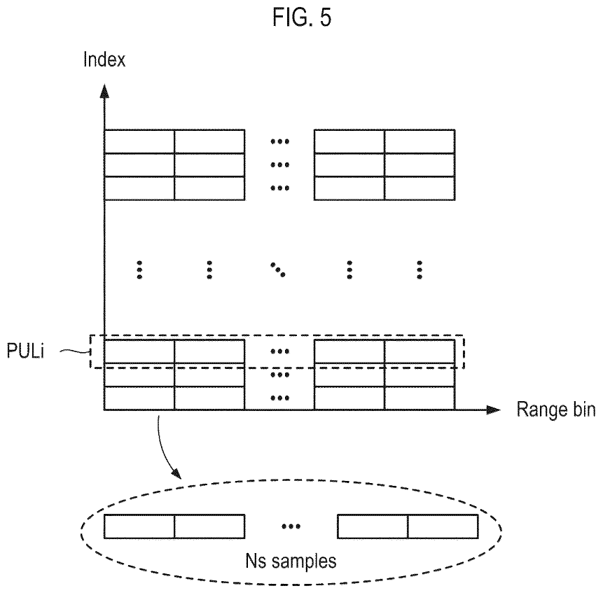

FIG. 5 is a diagram illustrating the operation of a detection device according to embodiments.

Referring to FIG. 5, range Fourier transform data defined by distance bins and indices of pulse signals is shown. It will be understood by those skilled in the art that each element of the distance bin corresponds to one sample, and the index axis corresponds to the time axis. In addition, each element of the index axis may correspond to one pulse signal.

According to the above-described (e.g., the processor of FIG. 1 or the Fourier processing circuit of FIG. 2), a range Fourier transform may be performed on the i-th (where i is a natural number) pulse signal PULi. For example, the range Fourier transform may be performed on the dechirped signal of the i-th pulse signal PULi, and range Fourier transform data according to the transform may be defined as R̅_{R,i}. Wen the number of samples in the i-th pulse signal PULi is Ns, the R_{R,i} may be defined as R_{R,i} [symbol] [R_{R,d}[i,0] . . . R_{R,d}[i, Nₛ−1]]^{T}. In this case, each element R_{R,d} is a sample of range Fourier transform data for the i-th pulse signal PULi.

The detection device may extract Ncons samples corresponding to a specific distance range for detection from Ns samples, and use the extracted samples for calibration and detection. The range Fourier transform data for Ncons samples may be defined as R_{R,i}^{cons}. The R_{R,i}^{cons} may be defined as

$${\underline{R}}_{R , i}^{cons} {=}^{Δ} {[ {R}_{R , d} [ i , 0 ] … {R}_{R , d} [ i , {N}_{cons} - 1 ] ]}^{T} .$$

The reference signal for the R_{R,i}^{cons} may be defined as R_{R,i,ref}^{cons}. When the detection device maintains the reference signal, the detection device according to embodiments may maintain R_{R,i,ref}^{cons} as R_{R,i-N,ref}^{cons}. The R_{R,i-N,ref}^{cons} is the reference signal for the (i-N)-th pulse signal, which is the pulse signal before N, which is the window size.

When the detection device updates the reference signal, the detection device according to embodiments may update R_{R,i,ref}^{cons} to

$$\frac{1}{N} {\sum }_{n = 0}^{N - 1} {\underline{R}}_{R , i - n - mod ( i , N )}^{cons} .$$

$$\frac{1}{N} {\sum }_{n = 0}^{N - 1} {\underline{R}}_{R , i - n - mod ( i , N )}^{cons} ,$$

which is an updated reference signal to be used in one detection section including the i-th pulse signal PULi, may be understood as calculating the average value of R_{R,i}^{cons} included in the detection section before one detection section. For example, in FIG. 3,

$$\frac{1}{N} {\sum }_{n = 0}^{N - 1} {\underline{R}}_{R , i - n - mod ( i , N )}^{cons}$$

for each of the (2N+1)-th pulse signal to the 3N-th pulse signal is an average value for the range Fourier transform data of the (N+1)-th pulse signal to the 2N-th pulse signal.

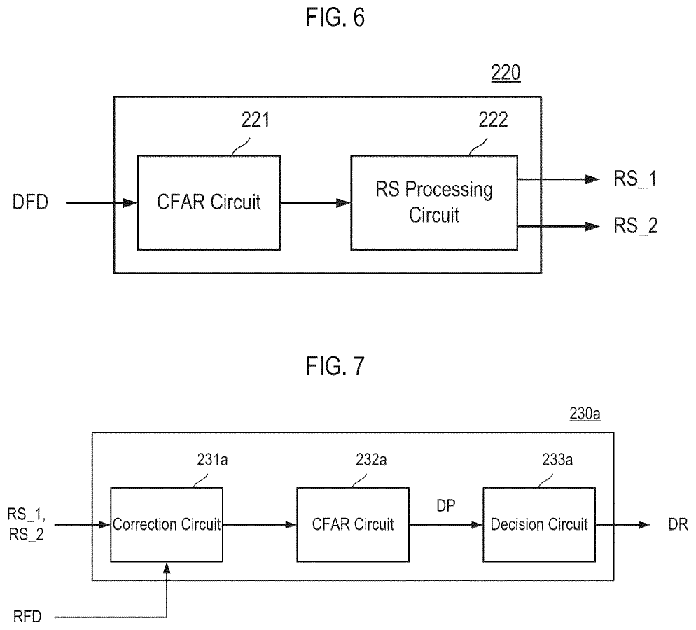

FIG. 6 is a block diagram illustrating a calibration circuit according to embodiments.

Referring to FIG. 6, the calibration circuit 220 according to embodiments may include a CFAR circuit 221 and/or a reference signal processing circuit 222.

The CFAR circuit 221 may perform CFAR on Doppler Fourier transform data DFD. With CFAR, regions with non-zero Doppler values in the Doppler Fourier transform data DFD may be indicated as detection flags indicating specific values. Accordingly, the presence or absence of a non-zero Doppler value may be identified through the CFAR circuit 221. The CFAR that the CFAR circuit 221 performs on the Doppler Fourier transform data DFD may be determined as two-dimensional (2D) CFAR.

The reference signal processing circuit 222 may determine whether a non-zero Doppler value exists based on the output result (e.g., detection flag) of the CFAR circuit 221 and process the reference signal according to the determination result. The reference signal processing circuit 222 may maintain the reference signal when a non-zero Doppler value exists, thereby preventing a signal change due to a human body from being reflected in the reference signal (or reducing the likelihood or occurrence thereof). Alternatively, the reference signal processing circuit 222 may update the reference signal when a non-zero Doppler value does not exist, thereby reflecting changes in the surrounding environment in the reference signal.

The reference signal processing circuit 222 may output a first reference signal RS_1 according to maintenance of the reference signal, or output a second reference signal RS_2 according to updating of the reference signal.

According to embodiments, the reference signal processing circuit 222 may update or maintain the reference signal in units of calibration sections. The size of one calibration section may be the same as (or similar to) that of one detection section. Alternatively, the reference signal processing circuit 222 may update or maintain the reference signal by applying a window to previously located pulse signal sections based on one pulse signal section.

FIGS. 7 to 9 are block diagrams illustrating detection circuits according to embodiments.

Referring to FIG. 7, a detection circuit 230a according to embodiments may include a correction circuit 231a, a CFAR circuit 232a, and/or a decision circuit 233a.

The correction circuit 231a may be provided with a maintained first reference signal RS_1 or an updated second reference signal RS_2 (hereinafter, referred to as a reference signal), and range Fourier transform data RFD, and may remove the reference signal from the range Fourier transform data RFD. For example, the correction circuit 231a may output corrected range Fourier transform data by subtracting R_{R,i,ref}^{cons} from R_{R,i}^{cons} for the i-th pulse signal.

The CFAR circuit 232a may perform CFAR on the corrected range Fourier transform data. The CFAR that the CFAR circuit 232a performs on the range Fourier transform data RFD may be understood as one-dimensional (1D) CFAR. Through CFAR, a detection flag DP for the corrected range Fourier transform data may be output.

The decision circuit 233a may determine whether a human body being a target exists based on the detection flag DP output from the CFAR circuit 232a. For example, when the detection flag DP indicates a specific value, the decision circuit 233a may determine that a human body exists within the detection range. The decision circuit 233a may output a detection result DR including information about whether a human body exists.

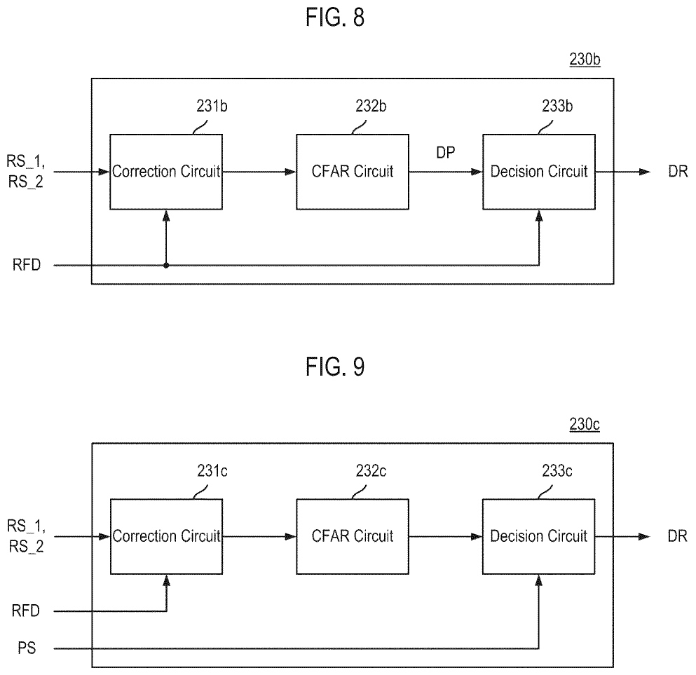

Hereinafter, detailed descriptions of examples overlapping with FIG. 7 in FIGS. 8 and 9 will be omitted.

Referring to FIG. 8, a decision circuit 233b included in a detection circuit 230b according to embodiments may receive the range Fourier transform data RFD. The decision circuit 233b may primarily determine whether a human body exists in close proximity based on the range Fourier transform data RFD.

According to embodiments, the decision circuit 233b may compare the magnitude of a plurality of samples included in the received range Fourier transform data RFD with a threshold value. When the magnitude of the plurality of samples is lower than the threshold value, the decision circuit 233b may determine that a human body exists at a very close distance.

When the magnitude of the plurality of samples is greater than the threshold value, the decision circuit 233b may operate according to the examples of FIG. 7. That is, a correction circuit 231b may output the range Fourier transform data corrected based on the reference signal, a CFAR circuit 232b may output the detection flag DP through CFAR for the corrected range Fourier transform data, and the decision circuit 233b may output the detection result DR according to the detection flag DP.

Referring to FIG. 9, a decision circuit 233c included in a detection circuit 230c according to embodiments may receive a plurality of pulse signals PS. The decision circuit 233c may primarily determine whether a human body exists in close proximity based on the plurality of pulse signals PS.

According to embodiments, the decision circuit 233c may compare the magnitude of the plurality of pulse signals PS in the time domain with a threshold value. When the magnitude of the plurality of pulse signals PS is lower than the threshold value, the decision circuit 233c may determine that a human body exists at a very close distance.

When the magnitude of the plurality of pulse signals PS is greater than the threshold value, the decision circuit 233c may operate according to the examples of FIG. 7. That is, a correction circuit 231c may output the range Fourier transform data corrected based on the reference signal, a CFAR circuit 232c may output the detection flag DP through CFAR for the corrected range Fourier transform data, and the correction circuit 231c may output the detection result DR according to the detection flag DP.

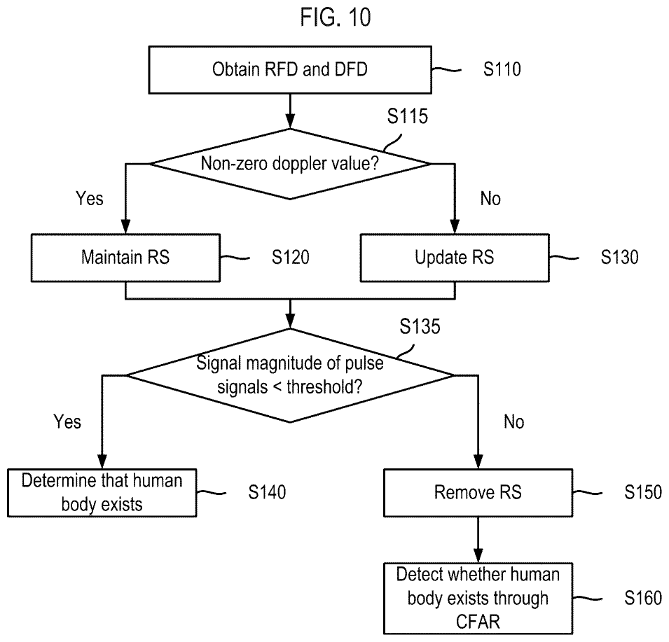

FIG. 10 is a flowchart illustrating a method of operating a detection device according to embodiments.

Referring to FIG. 10, in operation S110, a detection device may output (and/or obtain) the range Fourier transform data RFD through range Fourier transform for a plurality of pulse signals, and output (and/or obtain) Doppler Fourier transform data DFD through Doppler Fourier transform for the range Fourier transform data RFD. According to embodiments, in operation S115 the detection device may determine whether a non-zero Doppler value is included in the Doppler Fourier transform data.

In operation S120, the detection device may maintain the reference signal RS based on the presence of a non-zero Doppler value in the Doppler Fourier transform data DFD (e.g., “Yes” in operation S115). For example, the presence of non-zero Doppler values may be determined through CFAR for the Doppler Fourier transform data DFD.

In operation S130, the detection device may update the reference signal RS based on the absence of a non-zero Doppler value (e.g., “No” in operation S115). For example, in operation S130, the detection device may calculate the average value of the range Fourier transform data RFD corresponding to an arbitrary (or otherwise, given) calibration section among a plurality of calibration sections and update the reference signal RS to the calculated average value. According to embodiments, in operation S135, the detection device may determine with a signal magnitude of the plurality of pulse signals is lower than a threshold value.

In operation S140, the detection device may determine that a human body exists based on the signal magnitude of the plurality of pulse signals being lower than the threshold value (e.g., “Yes” in operation S135). That is, the detection device primarily performs detection based on signal magnitude.

In operation S150, the detection device may remove the reference signal RS from the range Fourier transform data RFD based on the signal magnitude being greater than the threshold value (e.g., “No” in operation S135). Through removal of the reference signal RS, the corrected range Fourier transform data that is ultimately subject to detection may be in a state where background signals (due to changes in the surrounding environment, and the like) are removed.

In operation S160, the detection device may detect a human body through CFAR for the range Fourier transform data corrected according to the removing in operation S150.

Through the operation method according to the above-described examples, false detections due to surrounding stationary objects, and the like may be reduced, and a human body may be detected at a very close distance.

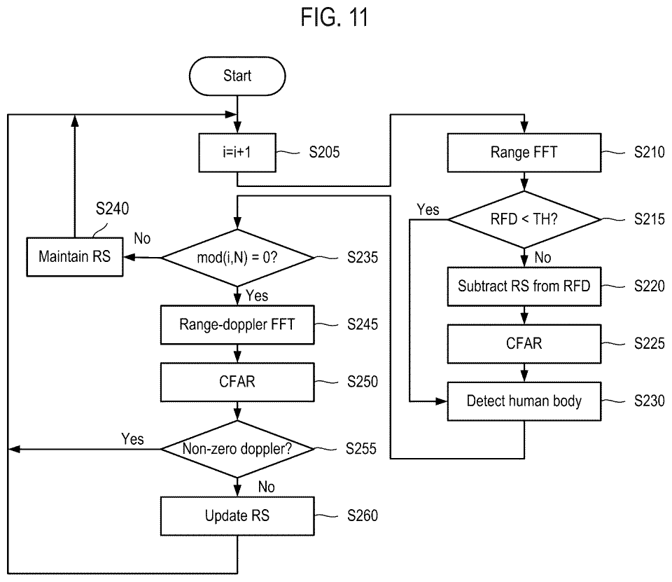

FIG. 11 is a flowchart illustrating a method of operating a detection device according to embodiments.

In FIG. 11, ‘i’ is defined as the index of a pulse signal. Initially, ‘i’ may be set to ‘0 (zero)’, and ‘N’, which is the number of pulse signals, may be set. The ‘N’ may be the number of pulse signals corresponding to one calibration section or one detection section according to the above-described examples. In addition, the reference signal RS may be set to an initial value.

According to embodiments, an operation of setting the above-described variables may be performed in advance.

In operation S205, the detection device increases ‘i’ by 1. The change in ‘i’ means that each operation of the operation method according to FIG. 11 is performed for a different pulse signal.

In operation S210, the detection device may perform range Fourier transform on the i-th pulse signal and obtain the range Fourier transform data RFD.

In operation S215, the detection device may determine whether the magnitude of each of the plurality of samples included in the range Fourier transform data RFD is lower than the threshold value. When the magnitude of the plurality of samples is greater than the threshold value, the detection device may remove the reference signal RS from the range Fourier transform data RFD in operation S220 (e.g., to obtain corrected range Fourier transform data). According to embodiments, when ‘i’ is within the first N-sized section (e.g., 1<i<N), the reference signal RS may be the initial value. For example, when ‘i’ is after the second N-sized section, the reference signal RS may be an updated or maintained value.

In operation S225, the detection device may perform CFAR on the corrected range Fourier transform data. According to embodiments, performing CFAR may result in an indication that a human body exists or an indication that a human body does not exist.

In operation S230, the detection device may detect whether a human body exists. For example, operation S230 may be performed in response to determining that the signal magnitude of each of the plurality of samples included in the range Fourier transform data RFD is lower than the threshold value (“Yes” in operation S215). Alternatively, operation S230 may be performed based on the result of CFAR according to operations S220-S225 in response to determining that the signal magnitude of each of the plurality of samples included in the range Fourier transform data RFD is greater than (or equal to) the threshold value (“No” in operation S215). When it is determined in operation S215 that the magnitude (e.g., the signal magnitude) of the plurality of samples is lower than the threshold value, the detection device may immediately (or promptly) perform operation S230 (e.g., without performing, or while skipping, operations S220 and S225). In other words, the detection device may determine that a human body exists in very close proximity (e.g., in operation S230). According to embodiments, operation S230 may only be performed in response to determining that the result of the CFAR performed in operation S225 indicates that a human body exists. Otherwise, the method may include determining that a human body does not exist.

According to embodiments, in response to determining that a human body exists in operation S230 the detection device 100 (or a device including the detection device 100) may adjust (e.g., decrease) a transmission power of a communication signal to be transmitted to the outside (e.g., via the transmission path 120 and/or one or more of the plurality of antennas 110a and 110b), skip transmission of the communication signal, and/or transmit the communication signal via a different antenna (e.g., different from an antenna determined to be close to the human body). According to embodiments, in response to determining that the result of the CFAR performed in operation S225 indicates that a human body does not exist, the detection device 100 (or a device including the detection device 100) may transmit the communication signal to the outside without adjusting the transmission to account for a nearby human. According to embodiments, the transmission of the communication signal may involve processing of the communication signal (e.g., by the transmission path 120) including, for example, modulating, upconverting, filtering, amplifying and/or encrypting the communication signal. According to embodiments, the detection device 100 (or a device including the detection device 100) may receive (e.g., via one or more of the plurality of antennas 110a and 110b) a response signal from an external device (e.g., a user equipment, a base station, etc.), process the response signal (e.g., by the reception path 130 to perform one or more among demodulating, downconverting, filtering, amplifying and/or decrypting on the response signal, and perform a further operation(s) based on the processed response signal. For example, the further operation(s) may include one or more of providing the processed response signal to a corresponding application executing on the detection device 100 (or a device including the detection device 100), storing the processed response signal, sending a further response signal to the external device, etc.

After the detection operation for the i-th pulse signal (operation S230), in operation S235, the detection device may determine whether the mode operation mod of ‘i’ and ‘N’ is ‘0 (zero)’ (e.g., a modulo operation performed with respect to ‘i’ and “N”). That is, the detection device may perform operations in units of N pulse signals (e.g., in units of calibration sections). In particular, operation S240 of maintaining the reference signal RS and operation S260 of updating the reference signal RS may be performed in units of plural calibration sections.

When the mode operation result is not ‘0 (zero)’, the detection device may maintain the reference signal RS in operation S240. In other words, one reference signal RS may be valid for at least N pulse signals. After operation S240, the detection device may repeat operations S205 to S230 again. That is, the detection device may perform a detection operation on the next pulse signal.

When the mod operation is determined to be ‘0’ in operation S235 e.g., when ‘i’ passes through one N section), the detection device may perform range-Doppler Fourier transform (e.g., on the first Fourier transform data) in operation S245.

In operation S250, the detection device may perform CFAR for Doppler Fourier transform data.

In operation S255, the detection device may determine whether a non-zero Doppler value exists based on a result of CFAR (e.g., a result of the CFAR performed in operation S250). When (e.g., in response to determining) the Doppler Fourier transform data does not include a non-zero Doppler value, the detection device may update the reference signal RS in operation S260.

When it is determined (e.g., in response to determining) in operation S255 that a non-zero Doppler value exists (e.g., is included in the Doppler Fourier transform data), the detection device may repeat operations S205 to S230. That is, the detection device may perform detection for the next pulse signal by using the same reference signal RS (or a similar reference signal RS).

According to the operation method according to the above-described examples, the reference signal RS may be maintained or updated depending on the presence or absence of a non-zero Doppler value, thereby reducing false detections due to changes in the surrounding environment. In addition, it is possible to detect a human body at a very close distance by comparing the magnitude of the range Fourier transform data RFD and the threshold value.

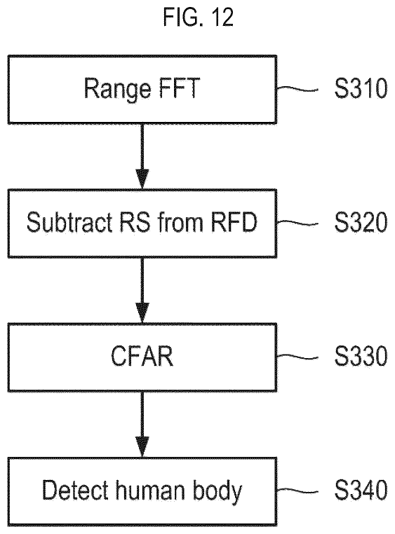

FIG. 12 is a flowchart illustrating a detection method of a detection device according to embodiments.

Referring to FIG. 12, in operation S310, the detection device may perform the range Fourier transform on a pulse signal. According to embodiments, operation S310 may be performed after operation S205 of FIG. 11. In this case, operation S310 may be performed on the i-th pulse signal.

In operation S320, the detection device may remove the reference signal RS from the range Fourier transform data RFD. In operation S330, the detection device may perform CFAR on the corrected range Fourier transform data. In operation S340, the detection device may detect whether a human body exists based on the result of CFAR according to operation S330. According to embodiments, the method discussed in connection with FIG. 12 may be performed without performing operation S215 discussed in connection with FIG. 11.

According to embodiments, the detection device may perform operation S235 of FIG. 11 after operation S340.

According to the operation method according to the above-described examples, detection may be performed based on range Fourier transform data from which the reference signal updated or maintained according to the surrounding environment is removed, thereby reducing false detections due to changes in the surrounding environment.

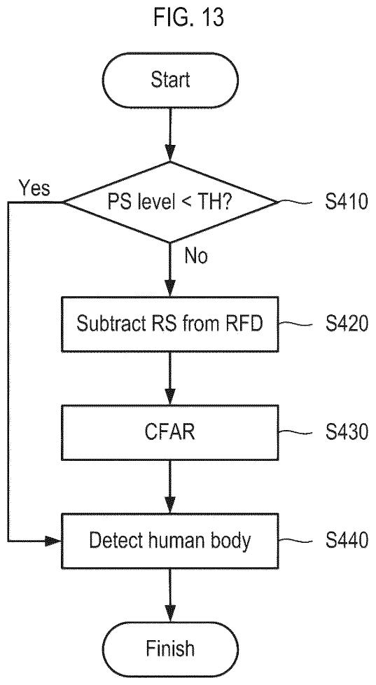

FIG. 13 is a flowchart illustrating a detection method of a detection device according to embodiments.

Referring to FIG. 13, in operation S410, the detection device may determine whether the magnitude of the plurality of pulse signals PS in the time domain is lower than the threshold value. That is, unlike FIG. 11, the object of comparison with the threshold value is the pulse signal PS.

When the magnitude of the pulse signal PS is greater than the threshold value, the detection device may remove the reference signal RS from the range Fourier transform data RFD in operation S420. In operation S430, the detection device may perform CFAR on the corrected range Fourier transform data RFD. In operation S440, the detection device may detect whether a human body exists. For example, when operation S440 is performed following operation S430, the detection device may detect whether a human body exists based on the result of CFAR. When it is determined in operation S410 that the magnitude of the plurality of samples is lower than the threshold value, the detection device may immediately (or promptly) perform operation S440 (e.g., without performing operations S420 and S430).

According to the above-described examples, the operation method is capable of detecting a human body at a very close distance by comparing the magnitude of the pulse signal in the time domain with the threshold value. In this case, operations due to the range Fourier transform may be reduced.

FIG. 14 is a diagram illustrating a result of range Fourier transform according to embodiments.

Referring to FIG. 14, the range Fourier transform results of the received pulse signal for various situations are shown in a distance-power domain. Sequentially, situations OTA1 and OTA2 are assumed in which there is no human body, a situation PALM1 is assumed in which a human body is present at zero distance, a situation PALM2 is assumed in which a human body is present at distance d1 from the detection device, a situation PALM3 is assumed in which a human body is present at distance d2 from the detection device, and a situation PALM4 is assumed in which a human body is present at distance d3 from the detection device. In this case, d1<d2<d3, and for example, d1 to d3 may be in units of several cm. In addition, the distance axis in FIG. 14 may be a proximity distance (e.g., several of centimeters to tens of centimeters).

The situation PALM1 that exists at zero distance shows a clearly distinct power spectrum from other situations OTA1, OTA2, and PALM2 to PALM4. In particular, in a very close distance range NR, the power of the situation PALM1 is significantly small compared to the power in the other situations OTA1, OTA2, and PALM2 to PALM4. Such a difference in power is because the pulse signal is emitted abnormally as the human body exists in very close proximity.

Accordingly, according to the above-described examples, the detection device is capable of detecting a human body at a very close distance by comparing the signal magnitude of a plurality of pulse signals with a threshold value.

FIG. 15 is a diagram illustrating detection results according to embodiments.

Referring to FIG. 15, according to embodiments, detection probabilities Pd of each threshold value Th for CFAR are shown for a case where the initial value of the reference signal is not updated (Transient) and a case where it is updated (Steady-state). The closer the detection probability Pd is to ‘1’, the higher the probability that the target is detected.

First, when we pay attention to the situation OTA2 where there is no human body in the case where the initial value is not updated, there is a section where the target detection probability Pd is ‘1’ due to the presence of an object other than a human body. In other words, when the initial value is used, false detection may occur. To the contrary, when the initial value is updated based on the pulse signal, the background signal for the situation OTA2 without a human body may be removed, so it is possible to confirm that the detection probability is reduced.

Conventional devices and methods for determining whether a body is close to an antenna rely on radar-based body proximity sensing (BPS). However, the conventional devices and methods fail to account for potential changes to a surrounding environment, such as the presence of objects (e.g., inanimate/non-living objects). As a result, the BPS of the conventional devices and methods produces an excessive amount of false positives (e.g., falsely detecting that a body is close to the antenna) and/or false negatives (e.g., falsely detecting that a body is not close to the antenna). Accordingly, the conventional devices and methods suffer from insufficient communication quality due to communication signals being transmitted at reduced power or not transmitted (in the event of a false positive), and/or direct an excessive amount of transmission power at the body (in the event of a false negative).

However, according to embodiments, improved devices and methods are provided for determining whether a body is close to an antenna. For example, the improved devices and methods may perform a calibration to update a reference signal representing a surrounding environment. The BPS performed by the improved devices and methods may use the reference signal to account for changes to the surrounding environment. Accordingly, the improved devices and methods prevent or reduce the occurrence of false positives and/or false negatives in the BPS. Therefore, the improved devices and methods overcome the deficiencies of the conventional devices and methods to at least improve communication quality and/or reduce an amount of transmission power directed at the body. Additionally, the improved devices and methods enable the detection of a body within an ultra-close range to the antenna.

According to embodiments, operations described herein as being performed by the detection device 100, the transceiver 115, the processor 140, the transmission path 120, the reception path 130, the LNA 131, the mixer 132, the filter 133, the ADC 134, the detection device 200, the Fourier processing circuit 210, the calibration circuit 220, the detection circuit 230, the CFAR circuit 221, the reference signal processing circuit 222, the detection circuit 230a, the correction circuit 231a, the CFAR circuit 232a, the decision circuit 233a, the detection circuit 230b, the correction circuit 231b, the CFAR circuit 232b, the decision circuit 233b, the detection circuit 230c, the correction circuit 231c, the CFAR circuit 232c and/or the decision circuit 233c may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

It will be understood that when an element is referred to as being “connected” or “coupled” to another element, it may be directly connected or coupled to the other element or intervening elements may be present.

Specific examples have been described above. The present disclosure may include not only the above-described examples, but also simple design changes or easily changeable examples. In addition, the present disclosure may include techniques that may easily modify and implement the examples. Therefore, the scope of the present disclosure should not be limited to the above-described examples, but should be defined by the claims described below as well as the claims and equivalents.

What is claimed is:

1. A detection device comprising:
processing circuitry configured to
perform range Fourier transform on a plurality of pulse signals to obtain first Fourier transform data,
perform Doppler Fourier transform on the first Fourier transform data to obtain second Fourier transform data,
maintain a reference signal in response to determining the second Fourier transform data includes a non-zero Doppler value,
update the reference signal in response to determining the second Fourier transform data does not include any non-zero Doppler values, and
determine that a nearby body exists in response to determining a signal magnitude of the plurality of pulse signals is lower than a threshold value,
remove the reference signal from the first Fourier transform data in response to determining the signal magnitude is higher than the threshold value to obtain corrected first Fourier transform data, and
detect that the body exists based on a constant false alarm rate (CFAR) for the corrected first Fourier transform data.

2. The detection device of claim 1, wherein the processing circuitry is configured to determine whether the second Fourier transform data includes the non-zero Doppler value based on a CFAR for the second Fourier transform data.

3. The detection device of claim 1, wherein processing circuitry is configured to:
maintain the reference signal in units of a plurality of calibration sections; and
update the reference signal in units of the plurality of calibration sections.

4. The detection device of claim 3, wherein the reference signal is set to an initial value in a first calibration section among the plurality of calibration sections.

5. The detection device of claim 4, wherein the processing circuitry is configured to maintain the reference signal at the initial value in response to determining the second Fourier transform data includes a non-zero Doppler value in a second calibration section among the plurality of calibration sections, the second calibration section being subsequent to the first calibration section.

6. The detection device of claim 5, wherein the processing circuitry is configured to:
calculate an average value of the first Fourier transform data corresponding to the first calibration section in response to determining the second Fourier transform data does not include any non-zero Doppler value in the second calibration section; and
update the reference signal with the average value.

7. The detection device of claim 1, wherein the signal magnitude includes a magnitude of each of a plurality of samples included in the first Fourier transform data.

8. The detection device of claim 1, wherein the signal magnitude includes magnitudes of the plurality of pulse signals in a time domain.

9. The detection device of claim 1, wherein the processing circuitry is configured to determine that the body exists based on a detection flag according to the CFAR for the corrected first Fourier transform data indicating a specific value.

10. The detection device of claim 3, wherein the processing circuitry is configured to:
maintain the reference signal based on a window, the window being movable in units of unit pulse signal sections; and
update the reference signal based on the window.

11. A method of operating a detection device, the method comprising:
performing range Fourier transform on a plurality of pulse signals to obtain first Fourier transform data;
performing Doppler Fourier transform on the first Fourier transform data to obtain second Fourier transform data; and
detecting that a body exists
in response to a signal magnitude of the plurality of pulse signals being lower than a threshold value, or
based on a constant false alarm rate (CFAR) for corrected first Fourier transform data, the corrected first Fourier transform data being obtained by removing a reference signal from the first Fourier transform data in response to the signal magnitude being higher than the threshold value, the reference signal being one of
a first reference signal maintained in response to determining the second Fourier transform data includes a non-zero Doppler value, or
a second reference signal updated in response to determining the second Fourier transform data does not include any non-zero Doppler values.

12. The method of claim 11, further comprising:
determining whether second Fourier transform data includes the non-zero Doppler value exists based on a CFAR for the second Fourier transform data.

13. The method of claim 11, wherein
the first reference signal in maintained in units of a plurality of calibration sections; and
the second reference signal is updated in units of the plurality of calibration sections.

14. The method of claim 13, wherein the second reference signal is updated including:
calculating an average value of the first Fourier transform data corresponding to one among the plurality of calibration sections; and
updating the second reference signal with the average value.

15. The method of claim 11, wherein the signal magnitude includes a magnitude of each of a plurality of samples included in the first Fourier transform data.

16. The method of claim 11, wherein the signal magnitude includes magnitudes of the plurality of pulse signals in a time domain.

17. The method of claim 11, further comprising:
comparing the signal magnitude and the threshold value.

18. A detection device comprising:
a transceiver configured to transmit and receive a plurality of pulse signals; and
processing circuitry electrically connected to the transceiver, the processing circuitry being configured to
maintain a reference signal in response to determining Doppler Fourier transform data on the plurality of pulse signals includes a non-zero Doppler value,
update the reference signal in response to determining the Doppler Fourier transform data does not include any non-zero Doppler value,
determine that a body exists in response to determining a signal magnitude of the plurality of pulse signals is lower than a threshold value,
remove the reference signal from range Fourier transform data for the plurality of pulse signals in response to determining the signal magnitude is higher than the threshold value to obtain corrected range Fourier transform data, and
detect that the body exists based on a constant false alarm rate (CFAR) for the corrected range Fourier transform data.

19. The detection device of claim 18, wherein the processing circuitry is configured to:
maintain the reference signal in units of a plurality of calibration sections; and
update the reference signal in units of the plurality of calibration sections.

20. The detection device of claim 18, wherein the signal magnitude includes a magnitude of each of a plurality of samples included in the range Fourier transform data.
